(19) United States
(12) Patent Application Publication
(10) Pub. No.: US 2024/0112220 A1
(43) Pub. Date: Apr. 4, 2024

(54) Programmatic lead generation

(71) Applicant: INTERACTIVE OFFERS LLC, BOCA RATON, FL (US)

(72) Inventors: JOSEPH LOMBAS, BOCA RATON, FL (US); WESLEY DESOUZA, DEERFIELD BEACH, FL (US); RAFAEL PEREIRA, NEWARK, NJ (US)

(73) Assignee: INTERACTIVE OFFERS LLC, BOCA RATON, FL (US)

(21) Appl. No.: 17/937,502

(22) Filed: Oct. 3, 2022

(51) Int. Cl. G06Q 30/02

(52) U.S. Cl. CPC G06Q 30/0257; G06Q 30/0249; G06Q 30/0277

(57) ABSTRACT

Methods, systems, and products are provided for programmatic lead generation. Embodiments include receiving, by a CTO ad server from an email client, a request for an advertisement (‘ad’) invoked by a user opening an email having embedded within it a CTO ad unit; selecting, by the CTO ad server from a database in response to the request, a CTO ad bundle, sending, by the ad server to the email client, a response with the selected CTO ad with its associated campaign ID and a redirect; receiving, by the CTO payload server in response to the email client invoking the redirect, an email address and the campaign ID; and administering, by the CTO payload server, an opt-in for a marketing campaign identified by the campaign ID with the email address.

### BACKGROUND

One conventional email marketing campaign is called Click-To-Opt-In (‘CTO’) which presents the user receiving an email with advertisements embedded within it with a special link that already contains the user's email address. A user clicking that link transmits the email address to the advertiser through the URL as the user hits the advertiser's landing page. In this way, the user opts-in to a subscription service and triggering with the user's permission a number of actions such as follow-up emails with additional information about particular offers, adding the email address to a subscription list, sending the user a protected download link, invoking a web page to be displayed to the user, and other actions as will occur to those of skill in the art.

This type of campaign has drawbacks from an advertiser's perspective. Some drawbacks include targeting, pricing, and budget control. For success in these conventional CTO campaigns, the recipient email list must include target users who are good candidates to buy the product or service being sold. Often the CTO link in the email sent to that user must be hardcoded making dynamic selections of ads more cumbersome.

Furthermore, in many cases, recipient email lists include target users who are not desirable targets for this type of advertising or for the product or service being sold. Even though some recipients on the email list may be poor targets, each recipient user is treated in the same way and command the same CTO price for serving the ad as the other users. Thus, if only 8 of every 10 recipients that click the CTO link match a basic requirement, such as target geographical location, the advertiser still pays for all recipients that opt-in to the subscription even though two recipient users who have opted-in were clearly not good candidates prior to sending them an email.

In addition to the difficulty in targeting good candidates, budgeting a conventional CTO campaign is made more difficult because different ad copies often have different rates for successful opt-ins. A good ad copy might go out to a list of 10,000 subscribers and get 2,000 opt-ins, but a poorly constructed ad copy might only get 100 from the same list. If the pricing model paid to an advertising agency is based on a per CTO opt-in, it becomes difficult predict how much a CTO campaign will cost to run be successful in supporting an advertiser's subscription.

It would be advantageous if there were a method and system for CTO advertisement that improved targeting recipients and could be tailored to fit advertising campaign budgets.

### BRIEF DESCRIPTION OF THE DRAWINGS

FIG. 1 sets forth a network diagram illustrating an example system (100) for programmatic lead generation according to embodiments of the present invention.

FIG. 2 sets forth a sequence diagram illustrating programmatic lead generation according to embodiments of the present invention.

FIG. 3 sets forth a flow chart illustrating an example method of programmatic lead generation according to embodiments of the present invention.

FIG. 4 sets forth a flow chart illustrating another example method of programmatic lead generation according to embodiments of the present invention.

### DETAILED DESCRIPTION OF EXAMPLE EMBODIMENTS

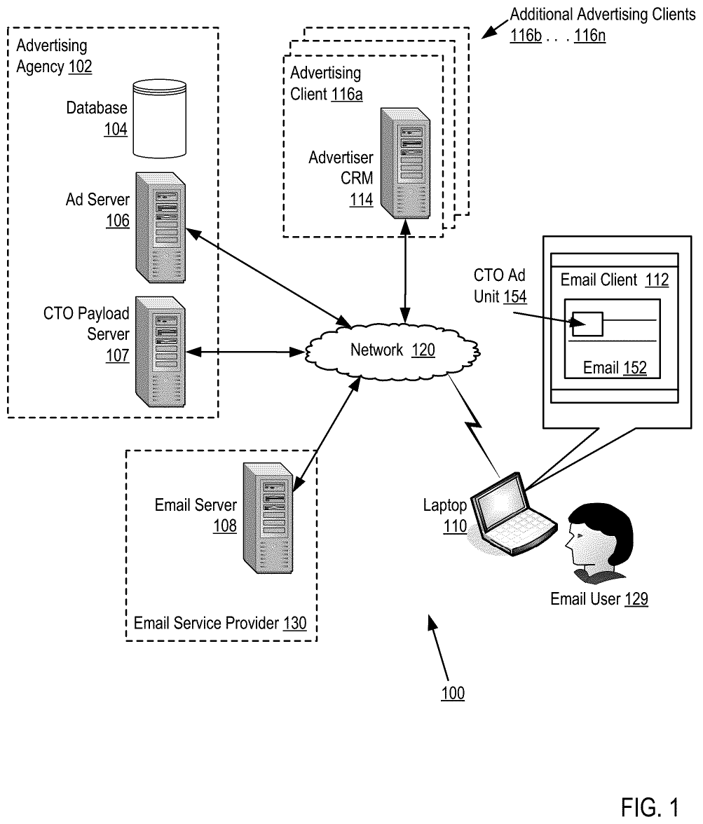

Example methods, systems, apparatuses, modules, and products for programmatic lead generation according to example embodiments of the present invention are described with reference to the accompanying drawings, beginning with FIG. 1. FIG. 1 sets forth a network diagram illustrating an example system (100) for programmatic lead generation according to embodiments of the present invention.

In the digital marketing context, a lead generally refers to contact with a potential customer. Programmatic lead generation according to embodiments of the present invention therefore generally refers to generating leads through programmed and configured automated computing machinery—software and hardware—as will occur to those of skill in the art.

The example of FIG. 1 includes an advertising agency (102). An advertising agency according to the example of FIG. 1 is an entity that serves ads for advertising clients also called advertisers. The advertising agency (102) operates a CTO ad server (106) having access to a database (104) containing CTO ads for selection and presentation to a user. An ad server is advertising software hosted on a server to manage online ad campaigns and used by publishers, advertisers, ad agencies, ad networks and the like to serve ads. Ad server software defines what ad to display at what specific time frame and on what website or mobile app to display the ad. There are many kinds of ad servers—open source, self-hosted, video, ad hoc ad server solutions, and others as will occur to those of skill in the art. Ad servers typically also collect data on ad performance such as number of impressions, clicks, CTR ratio and others as will occur to those of skill in the art. Such ad performance data is used to define targeting, perform ad budget control, frequency capping and other business and operational processes useful in programmatic lead generation according to embodiments of the present invention.

The example ad server of FIG. 1 is depicted as a CTO ad server for clarity of explanation and not for limitation. That is, the present disclosure is directed to CTO ads and therefore the ad server is so depicted. As will occur to those of skill in the art, ad servers useful according to embodiments of the present invention may serve ads without CTO functionality in addition to ads with CTO functionality. A CTO ad served by the server (106) of FIG. 1 provides functionality that when invoked opts a user in thereby giving permission to an advertising client to perform one or more actions such as sending additional emails, adding the user to a subscription list and other actions as will occur to those of skill in the art.

The ad server (106) of FIG. 1 is coupled for data communications to an advertising client customer relationship management system (‘CRM’) (114) operated by a client (116a) of the advertising agency (102) through a network. The CRM (114) of FIG. 1 is a technology for managing relationships and interactions with customers and potential customers. The CRM provides tools for contact management, sales management, agent productivity, and are often used to manage customer relationships across the entire customer lifecycle, spanning marketing, sales, digital commerce, and customer service interactions.

The ad server (106) and advertising client server (114) of FIG. 1 are also coupled for data communications with an email server (108) operated by an email service provider (130). An email service (‘ESP’) is a company that offers email services. Such services may be implemented through an email marketing platform that creates email templates, maintains subscriber lists, sends emails and provides statistics and results for individual campaigns. Some ESPs also offer consultancy, training, and other email related services.

The ESP (130) of FIG. 1 operates an email server (108). An email server is a computer system that sends and receives email. In order for a computer system to function as a mail server, it must include mail server software. This software allows the system administrator to create and manage email accounts for any domains hosted on the server. Mail servers send and receive email using standard email protocols. For example, the SMTP protocol sends messages and handles outgoing mail requests. The IMAP and POPS protocols receive messages and are used to process incoming mail.

The email service provider (130) of FIG. 1 may also administer subscription email lists for ad agencies, clients and other entities. Such subscription lists send advertising emails to email addresses for which a user has opted-in to receiving such emails.

The ad server (106), email server (108), and advertising client server (114) are also coupled for data communications with an email client (112) installed on a laptop (110) providing email with dynamic advertisements to an email user (129). An email client is a computer program to access and manage a user's email.

In the example of FIG. 1, the email service provider (130) sends an email client (112) an email (152) containing a CTO ad unit (154). When the email (152) is loaded by the email client (112) for display to the user, the CTO ad unit dynamically requests from the ad server (106) an ad that contains CTO functionality. Such functionality may include a link that when invoked opts the user in and gives permission to an advertiser to send emails to the email address. Such emails may be in the form of a subscription, promotional offers, information and others as will occur to those of skill in the art.

In the example of FIG. 1, upon the user (129) opening the email, the email client (112) administering the ad unit (154) sends the CTO ad server (106) a request for a dynamic ad that contains CTO functionality. The request typically includes information such as the email address, the source of the email, IP address, geographic location, and other information available to the ad unit as will occur to those of skill in the art.

Upon receiving the request for the ad, the CTO ad server (106) selects an ad bundle from the database. The CTO ad bundle may be selected based upon opt-in selection criteria such as profitability of serving the ad, demographics of the user, location of the user, email address which may be used for inclusion or exclusion, time of day, month, or year, number of times the ad has been served, price for opt-in, price of campaign, or other criterion as will occur to those of skill in the art. The ad bundle includes an ad, a campaign ID that identifies a particular marketing campaign for an advertising client.

The CTO ad server (106) sends the ad to the ad unit in the email rendered by the email client with a redirect to a CTO payload server associated with campaign ID. In the example of FIG. 1, the email client (112) receives the response with the selected CTO ad and redirect. The email client then displays the selected ad

Invoking the redirect opts a user in and sends to the CTO payload server an email address and the campaign ID associated with the ad. The CTO payload server administers the opt-in and redirects the user to a landing page for the advertising client. The CTO payload server may administer the opt-in by updating a subscription list with the ESP, updating the advertising client's CRM and in other ways as will occur to those of skill in the art.

In the example of FIG. 1, the CTO ad server (106) may also receive from the CTO payload server (107) an identification of the invocation of the redirect that identifies that the user has opted-in and record the opt-in. The CTO ad server may maintain a counter of opt-ins for a particular campaign or set of campaigns and use that number to update selection criteria, billing, cost analysis and other functions useful to advertising agencies as will occur to those of skill in the art.

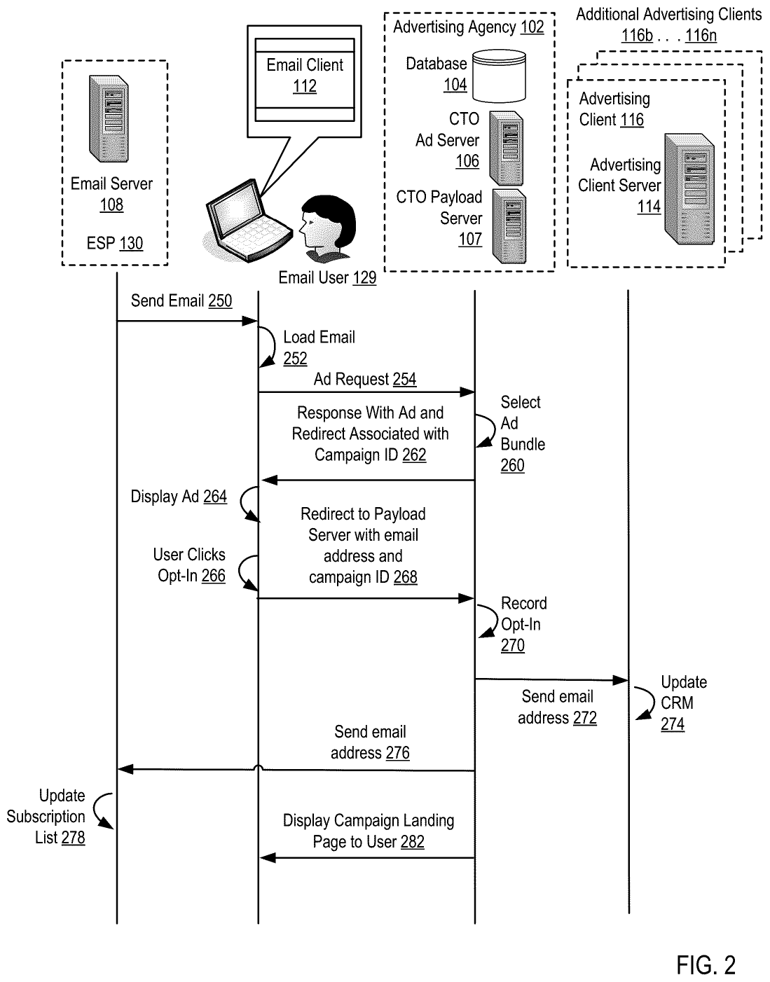

For further explanation, FIG. 2 sets forth a sequence diagram illustrating programmatic lead generation according to embodiments of the present invention. In the example of FIG. 2, an email server (108) of an ESP (130) sends (250) an email to an email client (112) running on a laptop (110) of an email user (129). Upon the user's opening the email, the email client (112) loads (252) the email, identifies a need for an ad in the email, and requests (254) an ad from the ad server (106) operated by the advertising agency (102).

In the example of FIG. 2, the ad server (106) receives the ad request (254) and selects (260) an ad bundle from the database (104) in dependence upon one or more opt-in selection criteria such as profitability, demographics, location, time, budget, price for opt-in, and so on.

The CTO ad bundle in the example of FIG. 2 includes an ad and an associated campaign ID. The CTO ad server (106) sends a response (262) containing the CTO ad with CTO functionality. An example of such functionality is set forth here:

<a href=“https://ioadserve.com/cto/adunit1/email@domain.com/redirect″>
<img src=“https://ioadserve.com/cto/adunit1/email@domain.com″>
</a>

In this example, ‘ioadserve.com’ keeps track of the last ad shown to a specific email address/adunit combination. If AD 1 was shown to ‘adunit1’ and ‘email@domain.com’, then the click will redirect to the CTO payload with AD 1's information including the associated campaign ID. At this point, the payload server can look up the delivery instructions for that specific Campaign ID and administer the opt—such as by sending the lead to the advertiser, updating a subscription list with an ESP and in other ways as will occur to those of skill in the art.

In the example of FIG. 2, the email client (112) receives the response and displays (264) the ad. Upon a user invoking the opt-in functionality such as clicking a link, the redirect to the CTO payload server (107) associated with the ad sends to the CTO payload server the email address and the campaign ID.

In the example of FIG. 2, the CTO payload server (107) records (270) the opt-in. In some embodiments, the CTO payload server (107) notifies the CTO ad server (106) of the opt-in. The CTO ad server may then increment a counter associated with campaign ID. In this way, the selection criteria associated with the campaign ID may also be updated and the opt-in may be recorded for pricing and payment from the advertising client.

In the example of FIG. 2, the CTO payload server (107) administers displaying a landing page associated to the user. Such a display may occur within the email client itself or invoking the display through a separate browser.

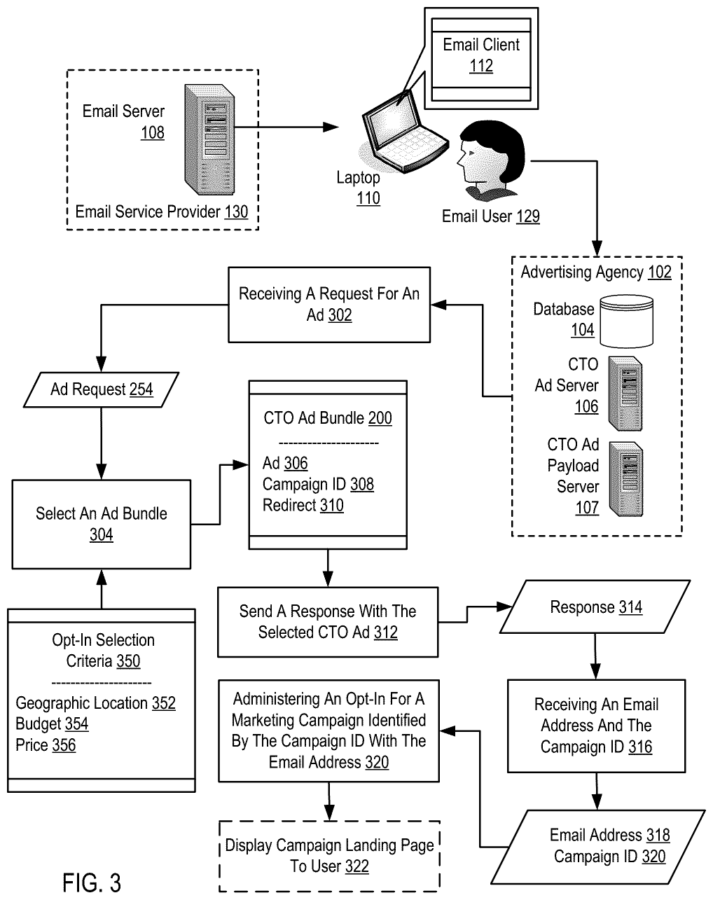

For further explanation, FIG. 3 sets forth a flowchart illustrating an example method for programmatic lead generation, according to embodiments of the present invention. The method of FIG. 3 includes receiving (302), by a CTO ad server (106) from an email client (112), a request (254) for an advertisement (‘ad’) invoked by a user (129) opening an email having embedded within it a CTO ad unit.

The method of FIG. 3 includes selecting (304), by the CTO ad server (106) from a database (104) in response to the request (254), a CTO ad bundle (200). The CTO ad bundle (200) includes a CTO ad (306), an associated campaign ID (308) and an associated redirect (310) to a CTO payload server (107), and

In the method of FIG. 3, selecting (304) a CTO ad bundle (200) includes selecting a CTO ad bundle (200) in dependence upon opt-in selection criteria (350). Opt-in selection criteria (350) may include a number of factors. In the example of FIG. 3 the selection criteria includes geographic location (352) associated with the email address, budgetary considerations of the advertising client (354), price (356) associated with a click to opt-in. These example selection criteria are provided for explanation and not for limitation may other selection criteria may be useful in programmatic lead generation according to embodiments of the present invention as will occur to those of skill in the art.

The method of FIG. 3 includes sending (312), by the CTO ad server (106) to the email client (112), a response (314) with the selected CTO ad (306) and with a redirect (310) to a CTO payload server (107) associated with the campaign ID. Invoking the redirect opts the user in giving an advertiser permission to advertise through the email address.

The method of FIG. 3 includes receiving (316), by the CTO payload server (107) in response to the email client (112) invoking the redirect, an email address (318) and the campaign ID (320). The user invoking the redirect the CTO payload server is made aware of the user opt-in and proceed accordingly.

The method of FIG. 3 includes administering (322), by the CTO payload server (107), an opt-in for a marketing campaign identified by the campaign ID (320) with the email address (318). Administering, by the CTO payload server, an opt-in may be carried out by updating a subscription with an email service provider associated with the advertising client, updating a customer relationship management system for the advertising client and in other ways as will occur to those of skill in the art.

Optionally, in the method of FIG. 3 includes displaying a campaign landing page to the user. Such landing pages may be core to a campaign and may provide a user with information an advertiser believes is compelling.

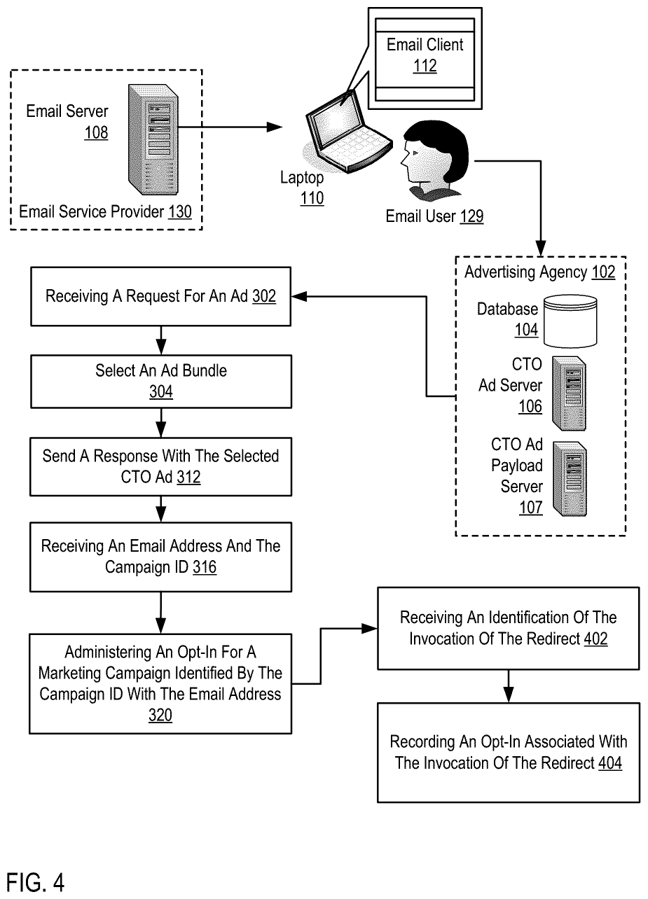

For further explanation, FIG. 4 sets forth another method for programmatic lead generation according to embodiments of the present invention. The method of FIG. 4 is similar to the method of FIG. 3 in that the method of FIG. 4 includes receiving (302), by a CTO ad server (106) from an email client (112), a request for an advertisement (‘ad’) invoked by a user (129) opening an email having embedded within it a CTO ad unit; selecting (304), by the CTO ad server (106) from a database (104) in response to the request, a CTO ad bundle, sending (312), by the ad server (106) to the email client (112), a response with the selected CTO ad with its associated campaign ID and a redirect; receiving (316), by the CTO payload server (107) in response to the email client (112) invoking the redirect, an email address and the campaign ID; and administering (320), by the CTO payload server (107), an opt-in for a marketing campaign identified by the campaign ID with the email address.

The method of FIG. 4 differs from the method of FIG. 3 in that the method of FIG. 4 includes receiving (402), by the CTO ad server (106) from the payload server, an identification of the invocation of the redirect and recording (404), by the CTO ad server (106), an opt-in associated with the invocation of the redirect.

Receiving (402), by the CTO ad server (106) from the payload server, an identification of the invocation of the redirect may be carried out by receiving the email address and associated campaign ID as a result of the users invoking the CTO functionality in the CTO ad.

Recording (404), by the CTO ad server (106), an opt-in associated with the invocation of the redirect may be carried out by incrementing an opt-in counter in dependence upon receiving an identification of the invocation of the redirect. In this manner, a counter may usefully record the number of ads served by the advertising agency for a particular campaign that resulted in the opt-in.

Recording (404), by the CTO ad server (106), an opt-in associated with the invocation of the redirect may be carried out by updating opt-in selection criteria in dependence upon the opt-in. Using the number or frequency of opt-ins may usefully inform an advertising agency of the success of the campaign itself. Such information may be useful to advertising clients in improving marketing campaigns.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for programmatic lead generation, the method comprising:
receiving, by a CTO ad server from an email client, a request for an advertisement (‘ad’) invoked by a user opening an email having embedded within it a CTO ad unit;
selecting, by the CTO ad server from a database in response to the request, a CTO ad bundle,
wherein the CTO ad bundle comprises a CTO ad having an associated campaign ID; and
wherein selecting a CTO ad bundle further comprises selecting an ad bundle in dependence upon opt-in selection criteria,
sending, by the ad server to the email client, a response with the selected CTO ad and a redirect to a CTO payload server associated with the campaign ID;
receiving, by the CTO payload server in response to the email client invoking the redirect, an email address and the campaign ID; and
administering, by the CTO payload server, an opt-in for a marketing campaign identified by the campaign ID with the email address.

2. The method of claim 1 further comprising displaying to the user a landing page associated with the campaign ID.

3. The method of claim 1 wherein administering, by the CTO payload server, an opt-in includes updating a subscription with an email service provider associated with the advertising client.

4. The method of claim 1 wherein administering, by the CTO payload server, an opt-in includes updating a customer relationship management system for the advertising client.

5. The method of claim 1 wherein administering, by the CTO payload server, an opt-in includes recording the opt-in.

6. The method of claim 1 further comprising:
receiving, by the CTO ad server from the payload server, an identification of the invocation of the redirect and
recording, by the CTO ad server, an opt-in associated with the invocation of the redirect.

7. The method of claim 6 wherein recording, by the CTO ad server, an opt-in associated with the invocation of the redirect further comprises incrementing an opt-in count in dependence upon receiving the identification of the invocation of the redirect.

8. The method of claim 6 wherein recording, by the CTO ad server, an opt-in associated with the invocation of the redirect further comprises updating opt-in selection criteria in dependence upon receiving the identification of the invocation of the redirect.

9. A system for programmatic lead generation, the system comprising automated computing machinery including a CTO ad server and a CTO payload server configured for:
receiving, by the CTO ad server from an email client, a request for an advertisement (‘ad’) invoked by a user opening an email having embedded within it a CTO ad unit;
selecting, by the CTO ad server from a database in response to the request, a CTO ad bundle,
wherein the CTO ad bundle comprises a CTO ad having an associated campaign ID, and
wherein selecting a CTO ad bundle further comprises selecting an ad bundle in dependence upon opt-in selection criteria,
sending, by the ad server to the email client, a response with the selected CTO ad and a redirect to a CTO payload server associated with the campaign ID;
receiving, by the CTO payload server in response to the email client invoking the redirect, an email address and the campaign ID; and
administering, by the CTO payload server, an opt-in for a marketing campaign identified by the campaign ID with the email address.

10. The system of claim 9 further configured for displaying to the user a landing page associated with the campaign ID.

11. The system of claim 9 wherein administering, by the CTO payload server, an opt-in includes updating a subscription with an email service provider associated with the advertising client.

12. The system of claim 9 wherein administering, by the CTO payload server, an opt-in includes updating a customer relationship management system for the advertising client.

13. The system of claim 9 wherein administering, by the CTO payload server, an opt-in includes recording the opt-in.

14. The system of claim 9 further configured for:
receiving, by the CTO ad server from the payload server, an identification of the invocation of the redirect and
recording, by the CTO ad server, an opt-in associated with the invocation of the redirect.

15. The system of claim 14 wherein recording, by the CTO ad server, an opt-in associated with the invocation of the redirect further comprises incrementing an opt-in count in dependence upon receiving the identification of the invocation of the redirect.

16. The system of claim 14 wherein recording, by the CTO ad server, an opt-in associated with the invocation of the redirect further comprises updating opt-in selection criteria in dependence upon receiving the identification of the invocation of the redirect.
